(19) United States
(12) Patent Application Publication
(10) Pub. No.: US 2002/0154008 A1
(43) Pub. Date: Oct. 24, 2002

(54) Decelerating inertia detector for vehicle

(76) Inventors: Clark Wu, Taipei (TW); Chin-Wei Tsao, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/839,493

(22) Filed: Apr. 23, 2001

(51) Int. Cl. B60Q 1/50

(52) U.S. Cl. 340/467; 340/665; 340/669; 340/693.6; 340/693.9; 340/432

(57) ABSTRACT

A decelerating inertia detector for detecting deceleration inertia energy of a moving vehicle is disclosed. The decelerating inertia detector includes a casing mounted on the moving vehicle, an inertia detecting mechanism for detecting a decelerating inertia energy of the moving vehicle and thereby generating a decelerating output signal, and an alarming means for generating an alarm signal. The inertia detecting mechanism includes a guiding slot formed in a casing, a rolling member movably contained in the guiding slot, and a switch unit arranged at the front open end of the guiding slot. The rolling member rolls to the front open end of the guiding slot when a deceleration inertia energy is applied to the decelerating inertia detector, and thereby collides the switch unit to generate the decelerating output signal.

### BACKGROUND OF THE INVENTION

1. Field of the Invention

The present invention generally relates to a deceleration indicating device for vehicle, and in particular to a decelerating inertia detector provided with an inertia detecting mechanism for detecting deceleration of a moving vehicle.

2. Description of the Prior Art

Based on the driving safety consideration and legal regulations, auxiliary brake indicating light known as third brake indicating light has become necessary equipment in addition to the original braking light on a motor vehicle. Therefore, most motor vehicles are provided with auxiliary brake indicating lights nowadays.

Due to the frame structure of the motor vehicle, it is pretty easy to install the auxiliary brake indicating light thereon. It is also very easy to control the auxiliary brake indicating light in connection with the original braking light by means of known circuit arrangement. When the driver presses the braking pedal to reduce the speed of the motor vehicle, the auxiliary brake indicating light will be turned on with the original braking light simultaneously.

Due to limitation on the frame structure of a motorcycle, it is difficult to install the auxiliary brake indicating light to the motorcycle to perform the brake indicating function. So, no auxiliary brake indicating light is available on the motorcycle.

It is noted that the helmet that motorist wears on the head may be the best place to install the auxiliary warning light for the motorcycle. The question is how to install the auxiliary warning light on the helmet and how to actuate the light turned on while the speed of the motorcycle is decreased.

Besides, bicycle has become a convenient transportation tool in addition to its sports function. Without the battery-installed design, it is impossible to provide any decelerating warning function to the bicycle.

Thus, it is desired to provide a deceleration indicating device for the motorcycle or bicycle.

### SUMMARY OF THE INVENTION

Accordingly, a primary object of the present invention is to provide a deceleration indicating device for indicating the deceleration of a moving vehicle. The deceleration indicating device is capable of serving as an auxiliary deceleration indicating light.

The other object of the present invention is to provide a decelerating inertia detector for detecting deceleration inertia energy of a moving vehicle. The decelerating inertia detector is capable of generating a decelerating output signal to indicating the deceleration of the moving vehicle.

The other object of the present invention is to provide a decelerating inertia detector suitable to be mounted on a helmet, serving as an auxiliary deceleration indicating light for motorcycles.

To achieve the above objects, the decelerating inertia detector in accordance with a preferable embodiment of the present invention is provided with a casing mounted on the moving vehicle, an inertia detecting mechanism for detecting a decelerating inertia energy of the moving vehicle and thereby generating a decelerating output signal, and an alarming means for generating an alarm signal. The inertia detecting mechanism includes a guiding slot formed in a casing, a rolling member movably contained in the guiding slot, and a switch unit arranged at the front open end of the guiding slot. The rolling member rolls to the front open end of the guiding slot when a decelerating inertia energy is applied to the decelerating inertia detector, and thereby collides the switch unit to generate the decelerating output signal.

### BRIEF DESCRIPTION OF THE DRAWINGS

The present invention will be apparent to those skilled in the art by reading the following description of preferred embodiments thereof, with reference to the accompanying drawings, in which:

FIG. 1 is a perspective view showing the decelerating inertia detector is adhered on a rear surface of a helmet in accordance with a preferred embodiment of the present invention;

FIG. 2 is a perspective view showing the decelerating inertia detector is mounted in a concave portion formed on a rear portion of a helmet in accordance with a preferred embodiment of the present invention;

FIG. 3 illustrates that the decelerating inertia detector of the present invention is mounted on a rear side of a motorcycle; and

FIG. 4 is a cross-sectional view of the decelerating inertia detector taken along line A-A of FIG. 2.

### DETAILED DESCRIPTION OF THE PREFERRED EMBODIMENTS

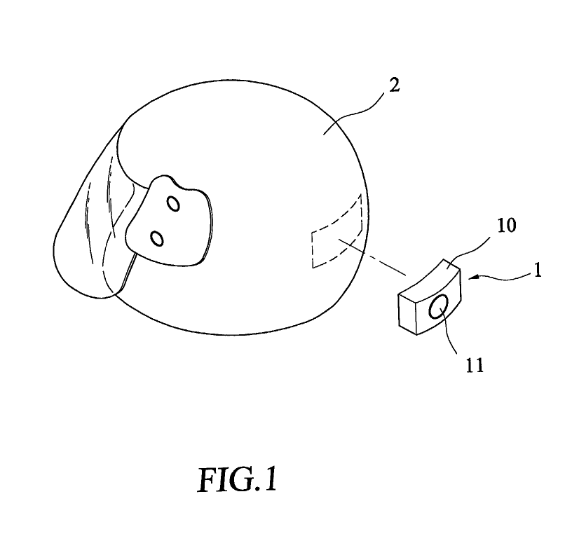

With reference to the drawings and in particular to FIGS. 1 through 4, a decelerating inertia detector for a helmet in accordance with a preferred embodiment of the present invention is shown. In this embodiment, the decelerating inertia detector 1 is adhered on a rear surface of the helmet 2 by means of any suitable adhesive material.

The decelerating inertia detector 1 of the present invention includes a casing 10 having a shape adapted to be adhered onto the helmet 2. The casing 10 is provided with an indicating light 11 which serves as an auxiliary brake indicating light for the helmet 2.

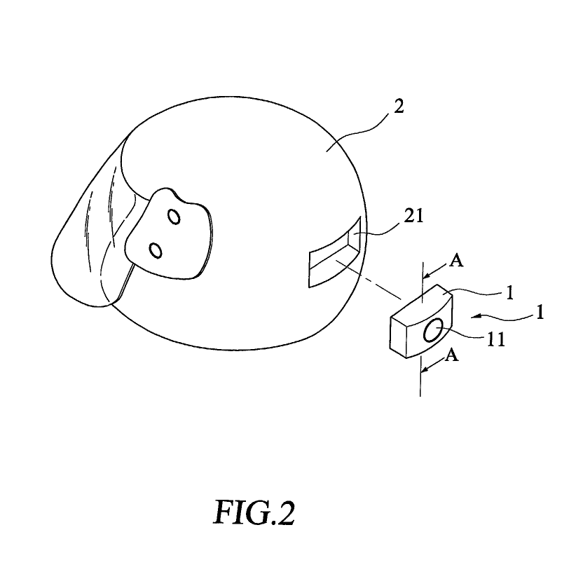

FIG. 2 is a perspective view showing the decelerating inertia detector 1 of the present invention is mounted in a concave portion 21 formed on the rear portion of the helmet 2. The decelerating inertia detector 1 may be integrally mounted with the helmet 2 to form a motorcycle helmet with an auxiliary brake indicating light.

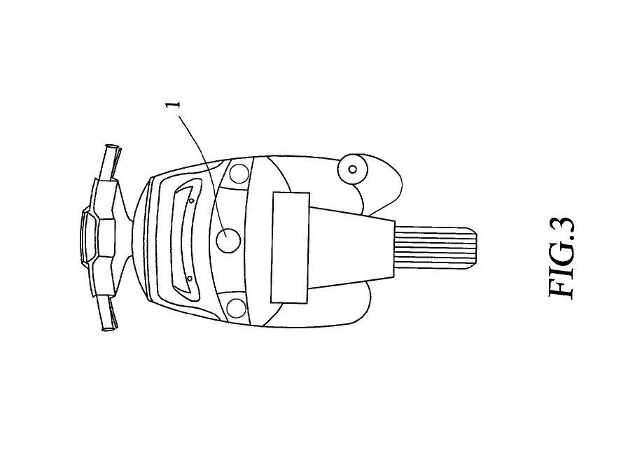

Alternatively, the decelerating inertia detector 1 may be mounted on a rear side of a motorcycle, as shown in FIG. 3, for alarming drivers behind the motorcycle.

The decelerating inertia detector 1 may detect the deceleration of the motorcycle by detecting the inertia energy applied to the motorcycle or helmet. Thereafter, the decelerating inertia detector 1 of the present invention can generate a visual indicating light by means of the indicating light 11 to alarm the drivers behind the motorcycle. Besides, an acoustic alarm may be further generated with the visual indicating light to further alarm the drivers.

As shown in FIGS. 1 to 3, the decelerating inertia detector 1 of the present invention is mounted on a helmet or a motorcycle as example. It is to be understood that the decelerating inertia detector 1 may be mounted on any other moving objects, such as a bicycle or a motor vehicle.

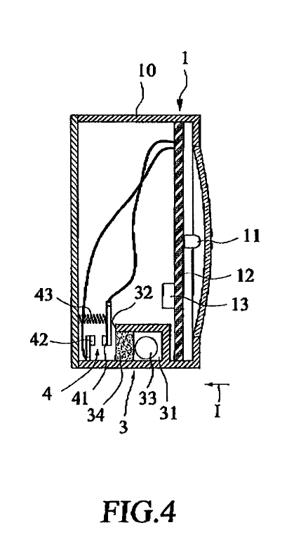

FIG. 4 is a cross-sectional view of the decelerating inertia detector 1 taken along line A-A of FIG. 2. As shown in the drawing, the decelerating inertia detector 1 includes a casing 10 defining an inner space therein. An indicating light 11 is mounted at the rear side wall of the casing 10. A circuit board 12 is mounted in the inner space of the casing 10, arranged with a control circuit for controlling the decelerating inertia detector. A plurality of batteries 13 may be held on the circuit board 12 for supplying electric power to the control circuit.

In the inner space of the casing 10 of the decelerating inertia detector 1, an inertia detecting mechanism 3 is mounted for detecting the deceleration inertia energy applied to the decelerating inertia detector 1. The inertia detecting mechanism 3 includes a guiding slot 30 extended in a direction along the moving direction I of the vehicle to be detected. The guiding slot 30 is formed with a front open end 32.

A rolling member 33 is movably contained in the guiding slot 30 of the inertia detecting mechanism 3. A switch unit 4 is arranged at the front open end 32 of the guiding slot 30 of the decelerating inertia detector 3. The switch unit 4 includes a first electrode 41 and a second electrode 42 spaced with a suitable distance therebetween. The first electrode 41 and the second electrode 42 are electrically connected to the circuit board 12. Preferably, the first electrode 41 is elastically supported by a spring 43.

An elastic element 43, such as sponge or spring, may be further inserted into the front open end 32 of the inertia detecting mechanism 3. The elastic element 43 is used to contain the rolling member 33 within the guiding slot 30 and capable of presenting the rolling member 33 from directly colliding the switch unit 4. The elastic element 43 has a suitable thickness enough to resist the rolling member 43 from colliding the switch unit 4 when the decelerating inertia energy is not applied to the decelerating inertia detector 1.

In normal condition, i.e. without detecting any decelerating inertia energy, the first electrode 41 and the second electrode 42 of the switch unit 4 are separated from each other. When a decelerating inertia energy is applied to the decelerating inertia detector 1, the rolling member 33 of the inertia detecting mechanism 3 rolls to the front open end 32 of the guiding slot 30, and then collides the switch unit 4 via the elastic element 43. Therefore, the switch unit 4 is capable of generating a decelerating output signal to the control circuit arranged on the circuit board 12 via the first electrode 41 and the second electrode 42, and thereby the indicating light 11 is actuated.

In conclusion, the present invention has the following special characters:

1. The present invention can be attached on the rear of a helmet or motorcycle, serving as an auxiliary deceleration indicating light to the driver behind the motorcycle.

2. The present invention can be integrally mounted in the helmet, forming a motorcycle helmet with an auxiliary deceleration indicating light.

3. Under emergency conditions requiring to reduce the speed of the moving vehicle, the present invention can generate a deceleration warning signal automatically by detecting the decelerating inertia energy.

Although the present invention has been described with respect to the preferred embodiments, it is contemplated that a variety of modifications, variations and substitutions may be done without departing from the scope of the present invention that is intended to be defined by the appended claims.

1. A decelerating inertia detector for a moving vehicle, comprising:
a casing mounted on the moving vehicle;
an inertia detecting mechanism for detecting a decelerating inertia energy of the moving vehicle, and thereby generating a decelerating output signal; and
an alarming means for receiving the decelerating output signal transmitted from the inertia detecting mechanism and generating an alarm signal.

2. The decelerating inertia detector as claimed in claim 1, the moving vehicle is a motorcycle helmet.

3. The decelerating inertia detector as claimed in claim 1, wherein the inertia detecting mechanism comprises:
a guiding slot formed in the casing, extended in a direction along a moving direction of the vehicle, having an front open end;
a rolling member movably contained in the guiding slot; and
a switch unit arranged at the front open end of the guiding slot for detecting the roll of the rolling member;
wherein the rolling member rolls to the front open end of the guiding slot along the guiding slot when the decelerating inertia energy is applied to the inertia detecting mechanism, and thereby collides the switch unit to generate the decelerating output signal.

4. The decelerating inertia detector as claimed in claim 3, wherein the rolling member is a ball.

5. The decelerating inertia detector as claimed in claim 3, an elastic element is further inserted in the front open end of the guiding slot to prevent the rolling member from directly colliding the switch unit.

6. The decelerating inertia detector as claimed in claim 5, wherein the elastic element has a thickness enough to resist the rolling member from colliding the switch unit when the decelerating inertia energy is not applied to the decelerating inertia detector.

7. The decelerating inertia detector as claimed in claim 1, wherein the alarming means comprises a visual indicator.

8. The decelerating inertia detector as claimed in claim 1, wherein the alarming means comprises an audio indicator.
